(19) United States
(12) Patent Application Publication
(10) Pub. No.: US 2007/0283529 A1
(43) Pub. Date: Dec. 13, 2007

(54) Plastic living hinge with metal support

(75) Inventors: Kenichi Hashizume, Kitagunma-gun (JP); Harri Lasarov, Espoo (FI); Markku Heino, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/450,906

(22) Filed: Jun. 8, 2006

(51) Int. Cl. E05D 1/00

(52) U.S. Cl. 16/225

(57) ABSTRACT

A living hinge structure has two plastic side sections and a plastic connecting section, wherein the plastic side sections are integrated with metal supports so as to enhance the strength of the living hinge structure. The metal supports can be metal inserts bonded to the plastic side sections in an over-molding process. Each of the metal supports can be located on the outside surface or the inside surface of the plastic section. When the metal sections are located on the outside surfaces, they can be used to restrict the opening angle of the hinge. The metal supports can also be a part of a device that uses the hinge for mechanically coupling two device parts. As such, the living hinge is directly integrated into the device without the need for post-assembling by using screws, adhesive, welding or heat stacking.

### FIELD OF THE INVENTION

The present invention relates generally to a living hinge and, more particularly, to the manufacturing of the hinges.

### BACKGROUND OF THE INVENTION

A small portable device, such as a mobile phone with a cover, requires one or more hinges to allow the portable device to open and close. To be used on a small portable device such as a mobile phone, the hinges must be sufficiently small. However, a small plastic living hinge is usually not strong enough mechanically to last a large number of flexing cycles. It is desirable that the hinges are of a small size and it is required that the hinges can be used for a large number of cycles.

### SUMMARY OF THE INVENTION

In a plastic living hinge having very thin but strong side sections to miniaturize the hinge element and thus the device, the present invention integrates one or more rigid metal plates in a side section to enhance the strength of living hinge structure. In particular, the metal plates are firmly bonded to the plastic side sections of a plastic living hinge. In a manufacturing process where a plastic living hinge is produced by over-molding, one ore more metal plates are used as inserts and the living hinge is over-molded so that the plastic adheres to the metal inserts in the mold to produce an enhanced living hinge structure. Furthermore, it is possible to fix the living hinge directly into the device without the need for post-assembling by using screws, adhesive, welding or heat stacking.

Thus, the first aspect of the present invention provides a living hinge structure which comprises: a first plastic section, a second plastic section, and a plastic connecting section connecting the first plastic section to the second plastic section, wherein the plastic connecting section is dimensioned to bend for changing an angle between the first and second plastic sections, wherein one or both of the plastic sections have a metal support integrated thereto. Each of the metal supports can be located on the upper or lower side of the plastic section. One of the metal supports located on the upper side can be extended to the plastic connecting section without being attached to the connecting section. The metal supports can be dimensioned such that the hinge structure can be only stretched out from a bending position up to a certain angle.

The second aspect of the present invention provides a method for producing a living hinge structure. The method comprises providing a plastic hinge part comprising a first plastic side section, a second plastic side section and a plastic connecting section connecting the first plastic side section to the second plastic side section, and integrating a metal support to one or both of the first and second plastic side sections. The integrating can be carried out by a molding process.

The third aspect of the present invention provides an electronic device having a first device part and a section device part mechanically engaged with a living hinge structure wherein the living hinge structure has a first plastic section connected to the first device part, a second plastic section connected to the second device part and a plastic connecting section connecting the first plastic section to the second plastic section, and wherein each of the first and second plastic sections has a metal support adhered thereto. The metal support can be a metal plate attached to the corresponding plastic section in a molding process. The metal support can also be a segment of the device part integrated with the corresponding plastic section. The electronic device can be a mobile phone, for example.

The present invention will become apparent upon reading the description taken in conjunction with FIGS. 1a to 8e.

### BRIEF DESCRIPTION OF THE DRAWINGS

FIG. 1a is a side view showing a living hinge structure, according to one embodiment of the present invention, in a bent position.

FIG. 1b is a side view showing the living hinge structure, according to one embodiment of present invention, in a stretched out position.

FIG. 1c is a plan view of a living hinge structure as shown in FIG. 1b.

FIG. 2a is a side view showing a living structure, according to another embodiment of the present invention, in a bent position.

FIG. 2b is a side view showing the living structure of FIG. 2a, in a stretched out position.

FIG. 2c shows a variation of the living hinge as shown in FIG. 2a.

FIG. 2d shows another variation of the living hinge as shown in FIG. 2a.

FIG. 3a is a side view showing a living hinge structure, according to another embodiment of the present invention, in a bent position.

FIG. 3b is a side view showing the living hinge structure of FIG. 3b in a stretched out position.

FIG. 4a is side view showing a living hinge structure, according to yet another embodiment of the present invention, in a bent position.

FIG. 4b is a side view showing the living hinge structure of FIG. 4b in a stretched out position.

FIG. 5a is a side view showing a living hinge structure, according to a different embodiment of the present invention, in a bent position.

FIG. 5b is a side view showing the living hinge structure of FIG. 5b in a stretched out position.

FIG. 5c is a side view showing a variation of the living hinge as shown in FIG. 5a.

FIG. 5d is a side view showing the living hinge of FIG. 5c in a stretched out position.

FIG. 6a is a side view showing a living hinge structure, according to a 5^{th} embodiment of the present invention, in a bent position.

FIG. 6b is a side view showing the living hinge structure of FIG. 6b in a stretched out position.

FIG. 7a is a side view showing a living hinge structure, according to a 6^{th} embodiment of the present invention, in a bent position.

FIG. 7b is a side view showing the living hinge structure of FIG. 7b in a stretched out position.

FIG. 8a shows a product having a living hinge structure, according to one embodiment of the present invention.

FIG. 8b shows the product in an open position.

FIG. 8c shows a device having metal parts in two device parts for supporting a living hinge, according to one embodiment of the present invention.

FIG. 8d shows a device having metal parts in two device parts for supporting a living hinge, according to another embodiment of the present invention.

FIG. 8e shows a device having metal parts in two device parts for supporting a living hinge, according to a different embodiment of the present invention.

### DETAILED DESCRIPTION OF THE INVENTION

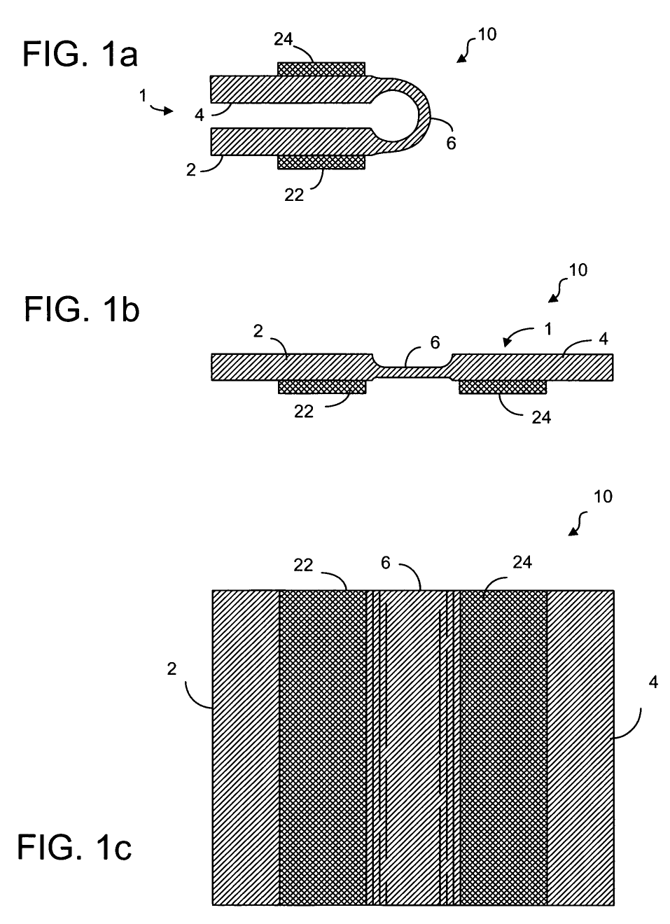

FIGS. 1a to 1c show a living hinge structure, according to one embodiment of the present invention. As shown, the living hinge structure 10 is made of a plastic hinge part 1 and two metal plates. The plastic hinge part 1 has a first side section 2 and a second side section 4 connected by a connecting section 6. The metal plate 22 is firmly attached to the first side section 2 and the metal plate 24 is firmly attached to the second side section 4. However, the connecting section 6 of the plastic hinge part is not attached to any metal plate. In manufacturing, it is preferred that the metal plates 22 and 24 are used as inserts and the plastic living hinge is over-molded so that the plastic parts (sections 2 and 4) adhere firmly to the metal parts (segments 22 and 24) to form a living hinge structure 10. The plastic material can be virtually any thermoplastic elastomer with sufficient fatigue resistance. For example, the plastic material can be a thermoplastic polyurethane, styrene block-copolymers, thermoplastic silicone elastomer, thermoplastic vulcanisate. Alternatively, a more rigid plastic material such as polyethylene, polypropylene or polyamide is used to provide potential characteristics of the plastic hinge part 1. The metal plates are made of basically any metal. It is preferred, however, that the metal plates 22, 24 are made of aluminum or stainless steel.

Before molding, the metal part is activated by physical or chemical etching or polymer coating so that the metal plate can be bonded to the plastic parts more firmly. Depending on the surface treatment, the plastic material needs to be carefully selected to achieve perfect bonding with the metal.

It is preferred that the metal plates 22, 24 are located at the outer surface of the plastic hinge part 1 so that the metal can also be used to protect the surface of the polymer hinge from scratches or other types of physical damages, which may cause a notch on the polymer hinge.

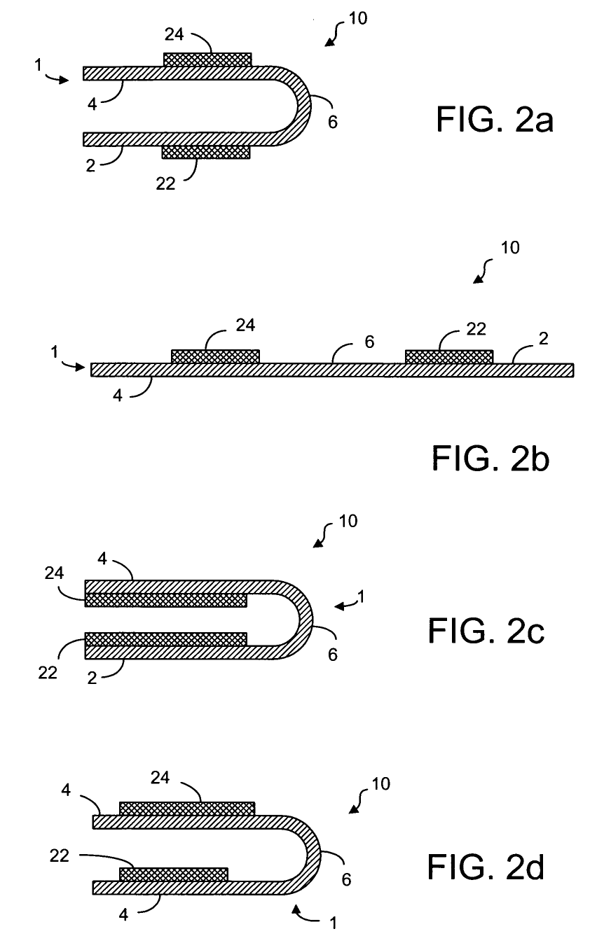

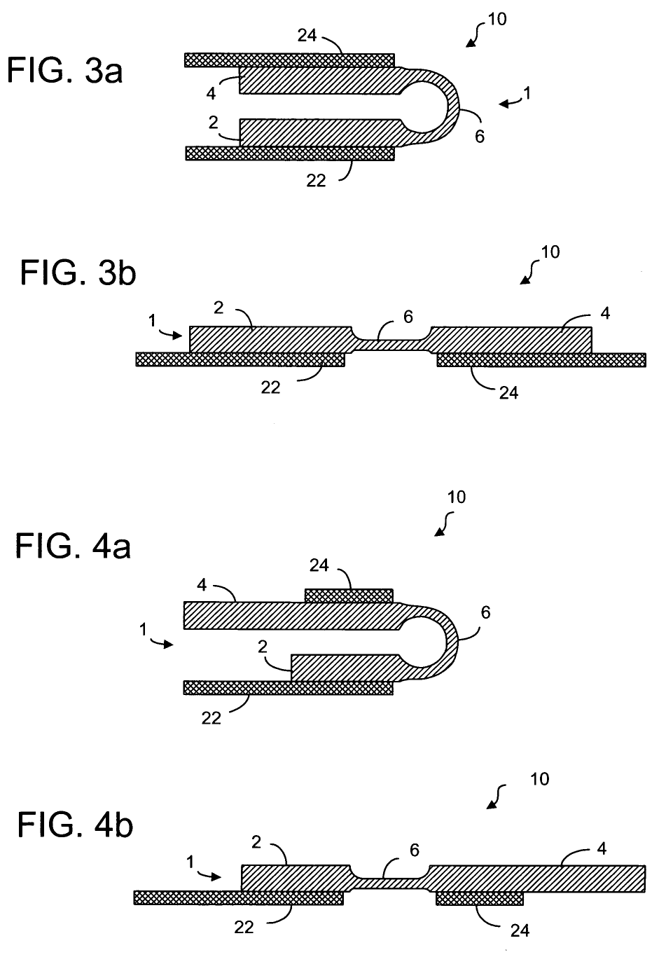

It should be noted that, as shown in FIG. 1c, the height of the metal plates 22, 24 are the same as the height of the plastic side sections 2 and 4. However, the height of the metal plates 22, 24 can be different from the height of the plastic side sections 2, 4. Furthermore, as shown in FIGS. 2a and 2b, the metal plates are narrower than the side sections. However, the width of the metal plates can be equal to or greater than the width of the plastic side sections. As shown in FIGS. 3a and 3b, the metal plates 22, 24 are wider than the plastic side sections 2 and 4.

Because each of the plastic side sections 2 and 4 has a metal support, the thickness of the side sections 2 and 4 can be reduced. For example, the thickness of the side sections 2 and 4 can be smaller or the same as the thickness of the connecting section 6, as shown in FIGS. 2a and 2b. FIG. 2a shows the living hinge structure 10 in a bending position whereas FIG. 2b shows the living hinge in a stretched out position. Furthermore, the metal supports or metal plates 22, 24 are located on the outer side of the plastic hinge part 1. The metal supports 22, 24 can be located on the inner side of the plastic hinge part 1, as show in FIG. 2c. Alternatively, one metal support 22 is located on the inner side and the other metal support 24 is located on the outer side of the plastic hinge part 1.

As shown in FIG. 4a and 4b, while the metal plate 22 is wider than the plastic side section 2, the metal plate 24 is narrower than the plastic side section 4. In the above embodiments, the living hinge structure 10 can be stretched out to a very wide angle. As shown in FIGS. 1b, 2b, 3b and 4b, the stretched out angle is substantially equal to 180 degrees.

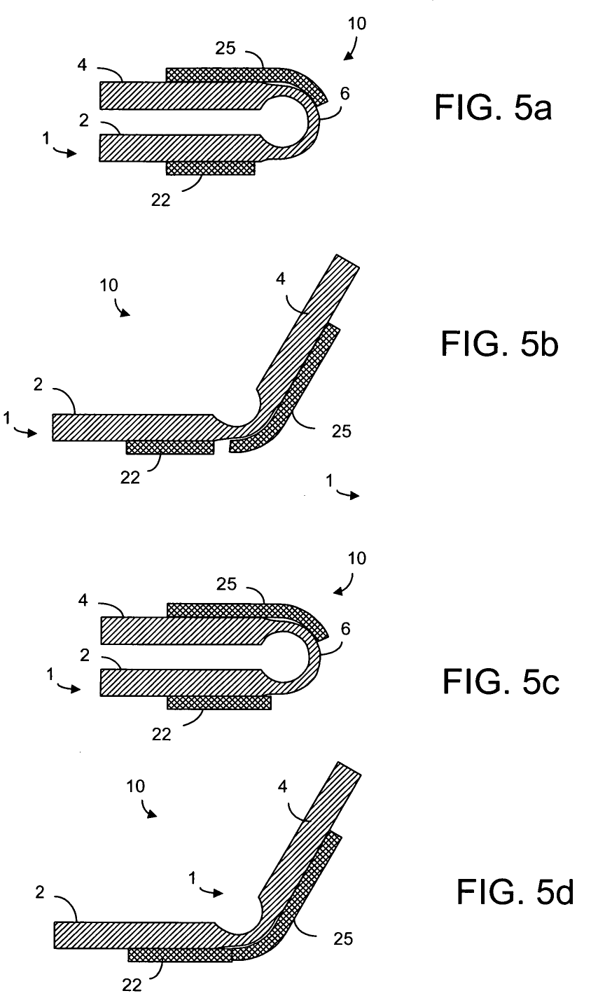

It is possible to extend one of the metal plates so that part of the metal plate covers at least part of the connecting section 6 of the plastic hinge part 1. As shown in FIG. 5a, part of the metal plate 25 is firmly attached to the plastic side section 4. However, the extended part of the metal plate 25 is not attached to the connecting section 6. With the extended part of the metal plate 25, it may not be possible to stretch out the living hinge structure more than a certain angle. For example, as shown in FIG. 5b, the stretched out angle is substantially equal to 120 degrees.

According to one embodiment of the present invention, the length and the arrangement of the metal plates 22 and 25 can be made to restrict the opening angle of the hinge and thus the opening angle of the device that uses the hinge. As shown in FIG. 5c and 5d, the metal plate 22 is extended toward the connecting part 6 such that when the hinge is opened to a predetermined angle, the metal plate 25 encounters the metal plate 22, preventing the opening angle from increasing further.

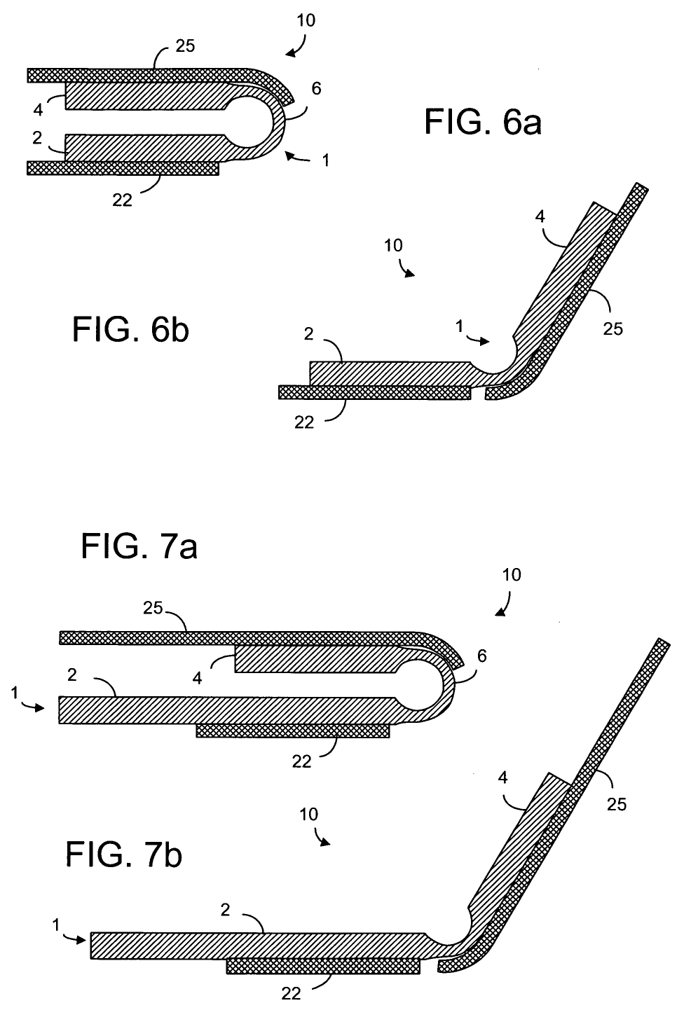

In FIGS. 5a to 5d, the metal plates 22 and 25 only cover part of the plastic side sections 2 and 4. However, it is possible to use a wider metal plates 22, 25 in a living hinge structure, as shown in FIGS. 6a and 6b. It is also possible that one of metal plates is wider than the bonded plastic side section while the other metal plate is narrower than the corresponding plastic side section, as shown in FIGS. 7a and 7b. Similar to FIGS. 5c and 5d, either one or both metal plates 22 and 25 in FIGS. 6a to 7b can be extended toward each other to reduce the opening angle, or shortened to increase the opening angle.

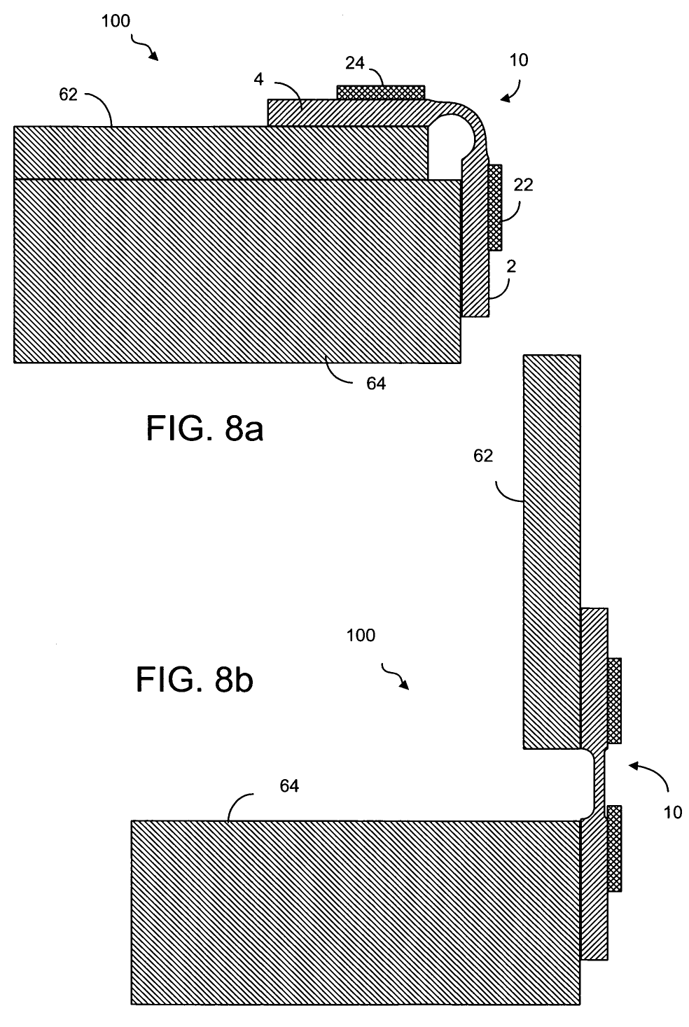

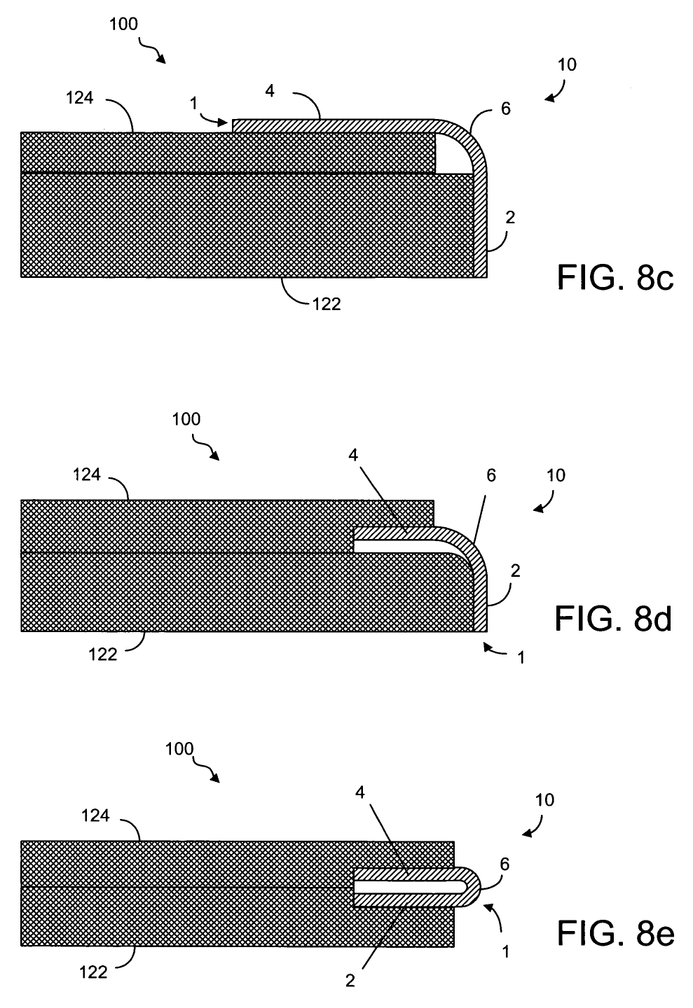

The living hinge structure 10 can be an integral part of a product. As shown in FIGS. 8a and 8b, the product or device 100 has a first plastic part 62 and a second plastic part 64. The first side section 2 and the second side section 4 of the plastic hinge part 1 can be molded together with the first plastic part 62 and the second plastic part 64, respectively, so that the connecting section 6 keeps the product parts 62, 64 together. At the same time, the metal plates 22 and 24 are caused to adhere to the first and second side sections 2 and 4 in the over-molding process. The product or device 100 can be a housing of the portable device. The product can be a container having a container body and a lid or cover, for example. The lid has a first plastic part 62 and the container body has a second plastic part 64. The material for the plastic parts 62 and 64 can be the same or different. Furthermore, the living hinge 10 can be made of a different plastic from the parts 62 and 64.

Alternatively, a part of the lid or the entire lid 124 is made of metal and the plastic side section 4 is adhered to the metal part of the lid 124. As such, the metal plate 24 may not be necessary. Likewise, a part of the device body or the entire device body 122 is made of metal and the plastic side section 2 is adhered to the metal part 122. As such, the metal plate 22 may not be necessary. The adhesion between the plastic side sections 2 and 4 to the metal parts 122 and 124 can be realized in the manufacturing process to make the plastic side sections an integral part of the device or product 100. As shown in FIG. 8c, the metal parts 124 and 122 are located on the inner side of the plastic hinge part 1. As shown in FIG. 8d, while the metal part 124 is located on the outer side of the hinge, the metal part 122 is located on the inner side of the plastic hinge part 1. As shown in FIG. 8e, both the metal parts 122 and 124 are location on the outer side of plastic hinge part 1.

The product or device 100, can be a portable electronic device, such as a mobile phone, a communicator device and the like. Thus, the plastic side sections 2 and 4 can be an integral part of a mobile phone, for example. As such, the mobile phone can be made thinner.

In sum, the present invention provides a method for producing a living hinge structure and integrating such a living hinge with an electronic device. The method comprises providing a plastic hinge part comprising a first plastic side section, a second plastic side section and a plastic connecting section connecting the first plastic side section to the second plastic side section; and integrating a metal support to at least one of the first and second plastic side sections. The integrating is carried out by a molding process. The present invention also provides a living hinge structure which comprises: a first plastic section; a second plastic section; and a plastic connecting means connecting the first plastic section to the second plastic section, wherein the plastic connecting means is dimensioned to bend for changing an angle between the first and second plastic sections; a first metal supporting means integrated with the first plastic section for providing mechanical support and a second metal supporting means integrated with the second plastic section for providing mechanical support. The first metal supporting means and the second metal supporting means are depicted as metal plates or metal parts of a device that uses the living hinge to mechanically couple a first device part to a second device part.

Thus, although the present has been described with respect to one or more embodiments thereof, it will be understood by those skilled in the art that the foregoing and various other changes, omissions and deviations in the form and detail thereof may be made without departing from the scope of this invention.

What is claimed is:

1. A living hinge structure, comprising:
a first plastic section;
a second plastic section; and
a plastic connecting section connecting the first plastic section to the second plastic section, wherein the plastic connecting section is dimensioned to bend for changing an angle between the first and second plastic sections, wherein at least one of the plastic sections has a metal support integrated to said at least one of the plastic sections.

2. The living hinge structure of claim 1, wherein the other one of the plastic sections has a further metal support integrated to said other one of the plastic sections.

3. The living hinge structure of claim 2, further having a first side and an opposing second side such that when the connecting section is in a bending position, the second side is located inside the first side, wherein both the metal support and the further metal support are located on the first side.

4. The living hinge structure of claim 2, further having a first side and an opposing second side such that when the connecting section is in a bending position, the second side is located inside the first side, wherein one of the metal support and the further metal support is located on the second side and the other one of the metal support and the further metal support is located on the second side.

5. The living hinge structure of claim 2, further having a first side and an opposing second side such that when the connecting section is in a bending position, the second side is located inside the first side, wherein both the metal support and the further metal support are located on the first side.

6. The living hinge structure of claim 5, wherein the metal support on the first plastic section has an extended section extending toward the plastic connecting section, leaving a gap between the extended section and the plastic connecting section.

7. The living hinge structure of claim 6, wherein when the connecting section is in the bending position, the connecting section can be stretched so as to increase an angle between the first and second plastic sections, and wherein the extended section and the further metal support are dimensioned such that when the angle between the first and second section sections reaches a predetermined angle, the further metal support encounters the extended section, preventing the angle from increasing further.

8. The living hinge structure of claim 2, wherein the metal support comprises a first metal plate and the further metal support comprises a second metal plate attached to the corresponding plates.

9. The living hinge structure of claim 2, wherein the living hinge structure is configured for mechanically coupling a first device part of an electronic device to a second device part of the electronic device, and wherein at least a part of the first device part is made of metal for providing the metal support to the first plastic section and at least a part of the second device part is made of metal for providing the further metal support to the second side plastic section.

10. The living structure of claim 9, wherein the electronic device comprises a mobile terminal.

11. A method for producing a living hinge structure, comprising:
providing a plastic hinge part comprising a first plastic side section, a second plastic side section and a plastic connecting section connecting the first plastic side section to the second plastic side section; and
integrating at least a metal support to at least one of the first and second plastic side sections.

12. The method of claim 11, further comprising:
integrating a further metal support to the other of the first and second plastic side sections.

13. The method of claim 12, wherein said integrating is carried out by a molding process.

14. The method of claim 11, wherein the metal support comprises a metal insert and the further metal support comprises a further metal insert and wherein said integrating is carried out by a molding process for binding the metal insert and the further metal insert to the corresponding first and second plastic side sections.

15. The method of claim 11, wherein the living hinge structure provides mechanical coupling between a first device part and the second device part of a device, and wherein the first device part includes a metal part for providing the metal support and the second device part includes a further metal part for providing the further metal support.

16. An electronic device, comprising:
a first device part;
a second device part mechanically coupled to the first device part to allow relative movements between the first and second device parts; and
a plastic hinge part, the plastic hinge part comprising
a first plastic section;
a second plastic section; and
a plastic connecting section connecting the first plastic section to the second plastic section, wherein the plastic connecting section is dimensioned to bend for changing an angle between the first and second plastic sections, and wherein the first device part comprises a metal part adhered to the first plastic section and the second device part comprises a further metal part adhered to the second plastic section.

17. The electronic device of claim 16, wherein the plastic hinge part has a first side and an opposing second side such that when the plastic connecting section is in a bending position, the second side is located inside the first side, wherein both the metal part and the further metal part are located on the first side.

18. The electronic device of claim 16, wherein the plastic hinge part has a first side and an opposing second side such that when the plastic connecting section is in a bending position, the second side is located inside the first side, wherein one of the metal part and the further metal part is located on the second side and the other one of the metal part and the further metal part is located on the second side.

19. The electronic device of claim 16, wherein the plastic hinge part has a first side and an opposing second side such that when the plastic connecting section is in a bending position, the second side is located inside the first side, wherein both the metal part and the further metal part are located on the second side.

20. A living hinge structure, comprising:
a first plastic section;
a second plastic section;
a plastic connecting means connecting the first plastic section to the second plastic section, wherein the plastic connecting means is dimensioned to bend for changing an angle between the first and second plastic sections;
first metal supporting means integrated with the first plastic section for providing mechanical support and
second metal supporting means integrated with the second plastic section for providing mechanical support.

21. The living hinge structure of claim 20, wherein the first metal support means comprises a first metal plate and the second metal supporting means comprises a second metal plate adhered to the corresponding plastic sections.
